(19) United States
(12) Patent Application Publication
(10) Pub. No.: US 2008/0239088 A1
(43) Pub. Date: Oct. 2, 2008

(54) EXTENDED DEPTH OF FIELD FORMING DEVICE

(75) Inventor: Toshiyuki YAMASHITA, Sakai-shi (JP)

Correspondence Address: SIDLEY AUSTIN LLP, 717 NORTH HARWOOD, SUITE 3400, DALLAS, TX, 75201, US

(73) Assignee: Konica Minolta Opto, Inc., Tokyo (JP)

(21) Appl. No.: 12/053,804

(22) Filed: Mar. 24, 2008

(30) Foreign Application Priority Data
Mar. 28, 2007 (JP) 2007-084008

(51) Int. Cl. H04N 5/225

(52) U.S. Cl. 348/222.1

(57) ABSTRACT

An extended depth of field forming device having: an image pickup element which has a plurality of pixels and performs photoelectric conversion of an optical image and generates image signals based on the optical image; an image pickup optical system which creates an optical image of a subject; and an image calculation section which calculates image signals generated by said image pickup element for generating an extended depth of field, wherein each pixel of the image pickup element performs photoelectric conversion of light including a plurality of wavelength regions, independently at each layer of the image pickup element located in different depth and the image pickup optical system forms a plurality of images at different positions on the optical axis and the image calculation section creates color information of the optical image of the subject for each pixel.

### RELATED APPLICATION

This application is based on Japanese Patent Application No. 2007-084008 filed on Mar. 28, 2007 in Japan Patent Office, the entire content of which is hereby incorporated by reference.

### BACKGROUND OF THE INVENTION

The present invention relates to an extended depth of field forming device and in particular to an extended depth of field forming device that uses an image pickup element that includes pixels that can independently perform photoelectric conversion of light of a plurality of wavelengths.

When dealing with an image, Red pixel, Green pixel and Blue pixel are collectively called a pixel in some case. In the present invention,

In image pickup devices for moving images or still images, so-called an extended depth of field formation techniques have been proposed in which blurred images are subjected to processing using software and converted to focused images.

The extended depth of field is an image created by performing an extended depth of field processing. The extended depth of field processing expands depth of field of an image pickup optical system. And, the effect of an extended depth of field processing calculation is expressed by a relationship between a pixel pitch (p) and a radius of a permissible circle of confusion for the optical system (σ). The permissible circle of confusion expresses a size of an image of a point produced on an image surface, where the point is on an object plane that corresponds to a virtual plane where the object exists. That is, when the pixel pitch (p) is less than the permissible circle of confusion (σ), blurring is larger than the pixel pitch, each point of the image is blurred. In other words, the extended depth of field processing calculation is a processing for making the permissible circle of confusion (σ) small by an image processing.

For example, a method has been proposed (in Unexamined Japanese Patent Application Publication No. 2003-309723 for example) in which by performing a convolution processing in which a focused image formed by a bifocal lens in which lens with different focal distances are made integral is superimposed on a blurred image, the quality of the blurred image is improved and an extended depth of field is obtained that is focused from near distances to far distances.

Also, a method has been proposed (in Unexamined Japanese Patent Application Publication No. 2003-319405 for example) in which the chromatic aberration of image pickup optical system, or in other words the difference in focal point distances due to wavelength of light is actively utilized and by using an image from short wavelength (blue) light, the image pickup region in which focusing is possible is extended to the near region side.

Image pickup elements using a Bayer pattern color filter which has been used in the past in digital cameras and video cameras, are used in the image pickup described above. The Bayer pattern will be described briefly using FIG. 5. FIGS. 5(a) and 5(b) are pattern diagrams showing the structure of the image pickup element including the Bayer pattern camera filter and FIG. 5(a) shows the structure of the image pickup surface IP of the image pickup element ID and FIG. 5(b) shows the cross section along B-B′ of FIG. 5(a).

In FIG. 5(a), the image pickup surface IP of the image pickup element ID has pixels IC arranged in two dimensions which are the horizontal and vertical directions and one of the color filters of the primary color system used in normal three color photography are arranged on each of the pixels IC. The three colors are red (called R hereinafter), green (called G hereinafter) and blue (called B hereinafter). The image pickup element itself may be an ordinary CCD (charge coupled device) type image pickup element or a CMOS (complementary metal oxide semiconductor) type image pickup element.

The color filter is arranged in the order RGRG from left to right in the uppermost example in the figure. In the second example in the figure, the color filter is arranged in the order GBGB such that G is under R in the uppermost example and B is under G in the uppermost example. In the third example the same arrangement as the uppermost example is repeated and in the fourth example the same arrangement as the second example is repeated and G is arranged in a checkered pattern and R and B are alternately filled in between. This arrangement is called the Bayer arrangement. It is to be noted that rather than a RGB primary color type color filter, a yellow (Y), magenta (M), cyan complementary color type color filter may also be used.

FIG. 5(b) is a cross-section along B-B′ of FIG. 5(a) and is an exploded view of the B pixel and the G pixel. Each pixel IC has a photoelectric conversion section PD that is formed by diffusion of impurities in the semiconductor substrate BP and one of the three color filters R, G and B is arranged in the photoelectric conversion section PD. In the example in the figure, a B color filter is arranged in the photoelectric conversion section PD of the left side pixel IC, while a G color filter is arranged in the photoelectric conversion section PD of the right side pixel IC. As a result, the photoelectric conversion section PD of the pixel IC photo-electrically converts and outputs only light of the wavelength transmitted by the color filter that is arranged therein.

It is to be noted that the structure of the image pickup element ID described herein is an outline to facilitate understanding of the characteristics and is not an accurate representation of the structure of the actual image pickup element.

As mentioned above, in the image pickup element ID with the Bayer arrangement, photoelectric conversion output for only one of the colors R, G and B from one pixel IC can be obtained. In order to reproduce the photographed image on a screen or as printed material, at least color information for the three colors R, G and B at each pixel IC position is required and thus, in an image pickup device using the image pickup element ID with the Bayer arrangement, in the subsequent image processing, so-called color interpolation processing in which color information for the three colors R, G and B are formed, is generally carried out at each pixel position.

As mentioned above, in the image pickup element ID with the Bayer arrangement, photoelectric conversion output for only one of the colors R, G and B from one pixel IC can be obtained. In particular, for R and B output only one out of four pixels can be obtained. Thus when photoelectric conversion output for image pickup element ID with the Bayer arrangement is used as it is for extended depth of field formation, the resolution is low for R and B in particular. As shown in Patent Document 2 for example, in the case where image quality improvement processes for blurred images is performed using images from B light in the near region, there is remarkable deterioration in quality of the image that was subjected to image improvement processing due to insufficient resolution.

In addition, as mentioned above, when color interpolation process is carried out and color information for the three colors R, G and B is added at each pixel position, a problem occurs in that due to color interpolation process, a so-called pseudo color occurs when a color that is different from the actual color is added. In Patent Document 1 and Patent Document 2, deterioration in image quality of the extended depth of field occurs due to the pseudo color in a similar manner.

The present invention was conceived in view of this situation and the object thereof is to provide an extended depth of field forming device which is capable of forming high quality extended depth of fields which are not affected by insufficient resolution and pseudo-colors and the like.

### SUMMARY

According to one aspect of the present invention, there is provided an extended depth of field forming device comprising: an image pickup element which has a plurality of pixels and performs photoelectric conversion of an optical image and generates image signals based on the optical image; an image pickup optical system which creates an optical image of a subject; and an image calculation section which calculates image signals generated by said image pickup element for generating an extended depth of field, wherein each pixel of the image pickup element performs photoelectric conversion of light including a plurality of wavelength regions, independently at each layer of the image pickup element located in different depth and the image pickup optical system forms a plurality of images at different positions on the optical axis and the image calculation section creates color information of the optical image of the subject for each pixel.

### BRIEF DESCRIPTION OF THE DRAWINGS

FIG. 1 is a block diagram showing the structure of the extended depth of field forming device of the present invention;

FIGS. 2(a) and 2(b) are pattern diagrams showing the structure of the image pickup element used in the present invention;

FIGS. 3(a) and 3(b) are pattern diagrams describing the first embodiment of the present invention;

FIGS. 4(a) and 4(b) are pattern diagrams describing the second embodiment of the present invention;

FIGS. 5(a) and 5(b) are pattern diagrams showing the structure of the image pickup element including the color filter with the Bayer arrangement.

### DETAILED DESCRIPTION OF THE PREFERRED EMBODIMENTS

The following is a description of the present drawing based on the embodiments shown in the drawing, but the present invention is not limited to these embodiments. It is to be noted that the same numbers refer to the same portions in the drawings and repeated descriptions thereof have been omitted.

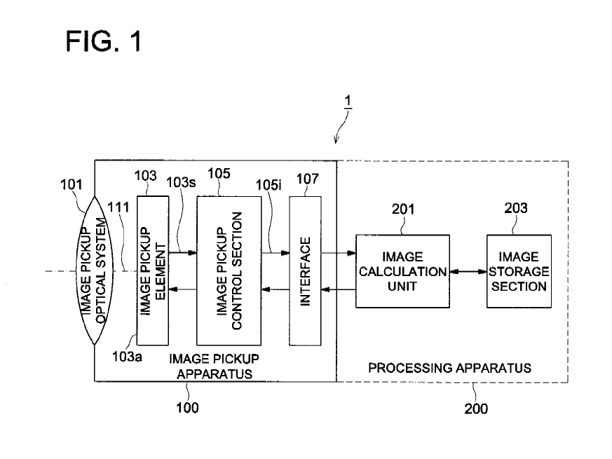

First, the structure of the extended depth of field forming device of the present invention will be described using FIG. 1. FIG. 1 is a block diagram showing the structure of the extended depth of field forming device of the present invention.

In FIG. 1, the extended depth of field forming device comprises an image pickup device 100 and a processing device 200 and the like. The image pickup device 100 comprises an image pickup optical system 101, an image pickup element 103, an image pickup control section 105, an interface 107 and the like.

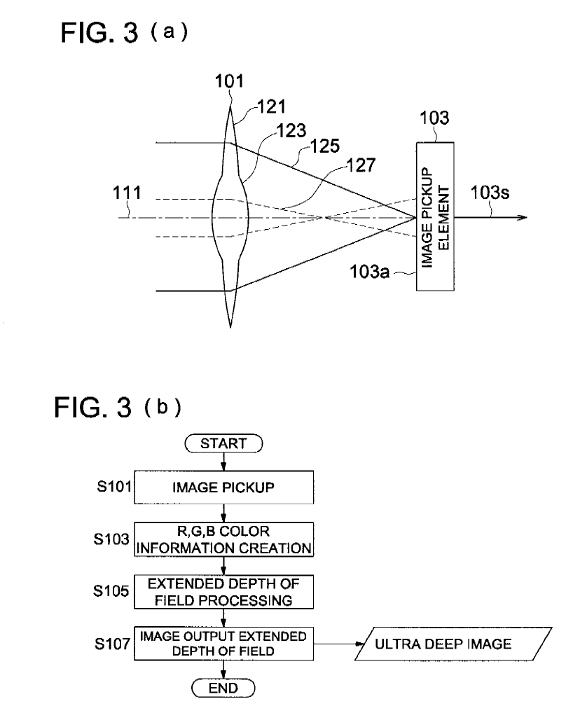

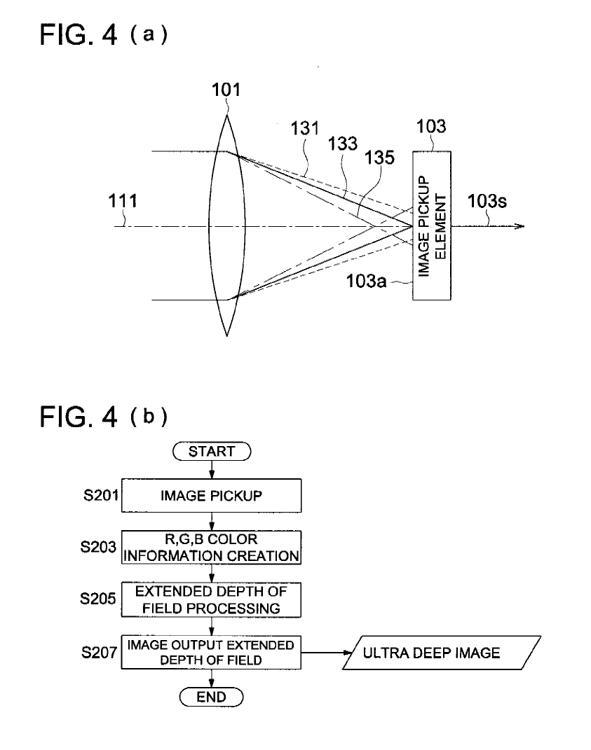

The image pickup optical system 101 forms an image of the subject on the image pickup surface 103a of the image pickup element 103 that is arranged vertically with the optical axis 111 on the optical axis 111. The structure of the image pickup optical system 103 is described using FIGS. 3 and 4.

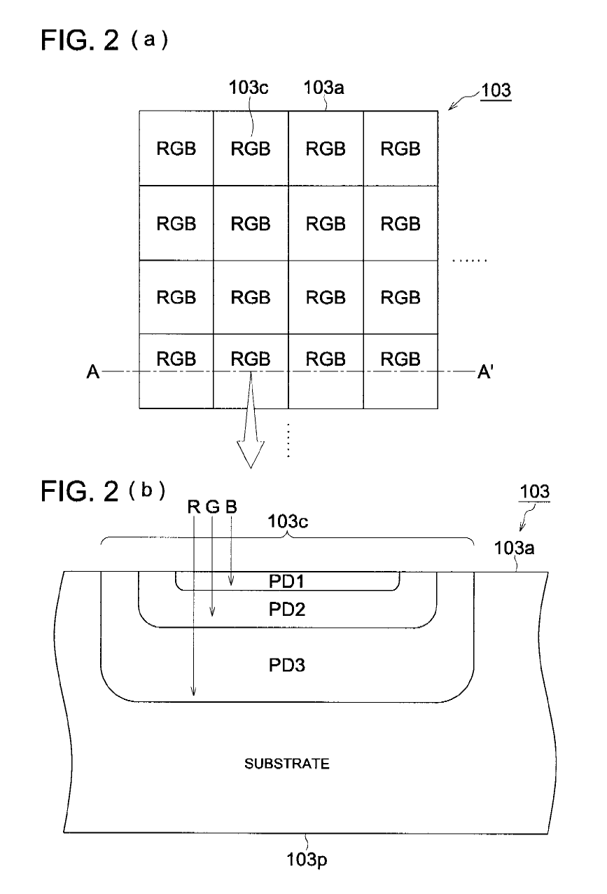

The image pickup element 103 performs photoelectric conversion of an image of the subject formed on the image pickup surface 103a and the image signal 103s is sent to the image control section 105. The photoelectric conversion operation is controlled by the image control section 105. The image pickup element 103 is described in detail in FIG. 2.

The image control section 105 may have a central processing unit (CPU) as its core and it controls the photoelectric conversion operation of the image pickup element 103 and also converts the image signal 103s of the photographic element 103 to digital image data 105i and sends it to the processing section 200 via the interface 107. Furthermore the image control section 105 controls the overall operations of the image pickup device 100.

The interface 107 connects the image pickup device 100 and the processing device 200 and relays data and controls signals and the like.

The processing section 200 comprises an image calculation section 201 and image protection section 203.

The image calculation section 201 may, for example, comprise a personal computer (PC) and software and an example is dedicated system which is the core of the CPU as well as the software. The image calculation section 201 may also be the CPU of information devices such as cellular phones and the like as well as the software.

The image calculation section 201 receives image data 105i form the image control section 105 via the interface 107 and the extended depth of field is calculated from the image data 105i. The calculation method of the extended depth of field may be the method shown in Patent Document 1 or Patent Document 2 or some other method.

The image protection device 203 may, for example, comprise a hard disk, memory or the like, and store the extended depth of field calculated at the extended depth of field calculation section 201. Alternatively, the image data 105i created at the image pickup control section 105 may be temporarily stored in the image storage section 203 and then sent to the image calculation section 201 via the interface 107 and subjected to extended depth of field processing at the image calculation section 201, or the image data 105i created at the image pickup control section 105 may be stored in the image storage section 203 via the interface 107 and then subjected to extended depth of field processing at the image calculation section 201. In the present invention, the image storage section 203 is not a required component.

Aside from the configuration in FIG. 1, a configuration may be considered in which the interface 107 is used as a hub and the image calculation section 201 and the image storage section 203 and the like which comprise the processing section 200 are arranged in a series. Alternatively, the structure may be such that the processing device 200 and the image pickup device 100 may be provided separately and in the case where x86 CPU is used as the image calculation section 201, each of the devices that comprise the processing unit 200 including the CPU share one FSB (front side bus) and are arranged in a series. In addition, the processing device 200 may be built into the image pickup section 100. In this case, the extended depth of field forming device 1 is the same as the image pickup device 100.

Next, the image pickup element 103 used in the present invention 103 is described using the FIGS. 2(a) and 2(b). FIGS. 2(a) and 2(b) are pattern diagrams showing the structure of the image pickup element 103 used in the present invention and FIG. 2(a) shows the configuration seen from the image surface 103a side of the image pickup element 103 and FIG. 2(b) is a cross section along A-A′ of FIG. 2a. The image pickup element 103 shown herein is a so called spectroscopic image pickup element and the structure thereof may for example be that described in Japanese National Publication No. 2002-513145. It is to be noted that the structure of the image pickup element 103 described herein is an outline to facilitate understanding of the characteristics and is not an accurate representation of the structure of the actual image pickup element.

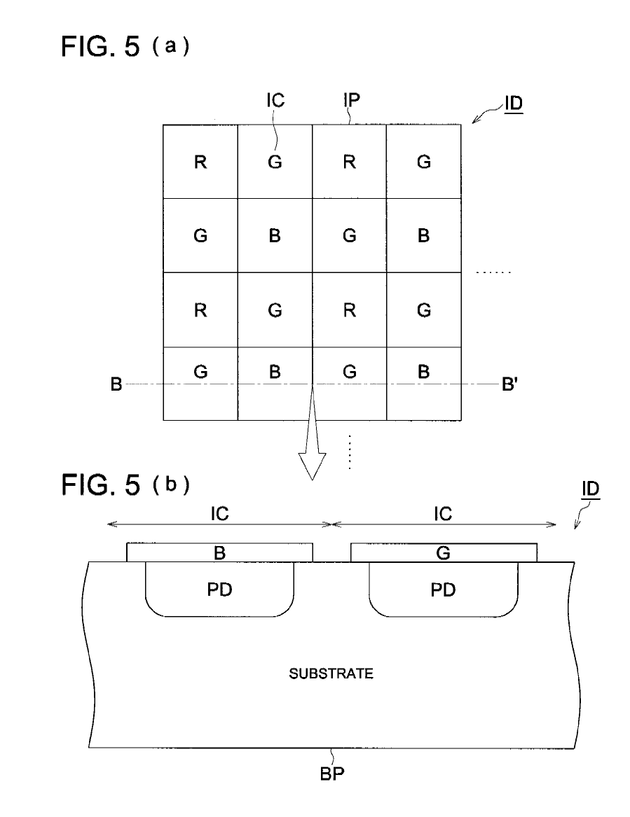

In FIG. 2(a), the image pickup surface 103a of the image pickup element 103 has pixels 103c arranged in two dimensions which are the horizontal and vertical directions. Unlike the image pickup element ID having the Bayer arrangement shown in FIG. 5, a color filter may be arranged on each of the pixels in the image pickup element 103. The spectroscopic image pickup element is usually formed by a CMOS structure.

FIG. 2(b) is a cross section along A-A′ of FIG. 2(a) and is an exploded view of the cross-section of one pixel 103c. One pixel 103c has a photoelectric conversion section PD3 that is subjected to deep diffusion of N type impurities formed on the P type semiconductor substrate 103p. The contact depth of the photoelectric conversion section PD3 is approximately 2 μm and mainly R light is photoelectrically converted. P type impurities are diffused inside the photoelectric conversion section PD3 and the photoelectric conversion section PD2 is thereby loaded. The contact depth of the photoelectric conversion section PD2 is approximately 0.6 μm and mainly G light is photoelectrically converted. Furthermore, N type impurities are shallowly diffused inside the photoelectric conversion section PD2 and the photoelectric conversion section PD1 is thereby formed. The contact depth of the photoelectric conversion section PD1 is approximately 0.2 μm and mainly B light is photoelectrically converted.

Light of the wavelength of the three colors R, G and B respectively are called λr, λg and λb and each of the wavelength regions from FIG. 8 in “International Publication No. WO/1999/056097” are as follows:

500 nm≦λr

400 nm≦λg≦700 nm

λb≦600 nm

As described above, in the image pickup element 103 in the present invention, the color filter is not used, but the difference in the light absorption wavelength in the depth direction of pixel 103 is utilized and color information for the three colors R, G and B at one pixel 103c can be obtained. In order to fetch multiple images in the optical axis direction, a transmission type image pickup element which uses organic material can be superposed but allowing wavelength selection in the semiconductor structure as in the case of the spectroscopic image pickup element of FIGS. 2(a) and 2(b) gives excellent compactness, stability and assembly and is thus favorable.

### First Embodiment

Next, the first embodiment of the present invention will be described using FIGS. 3(a) and 3(b). FIGS. 3(a) and 3(b) are pattern diagrams describing the first embodiment of the present invention. FIG. 3(a) shows the structure of the image pickup optical system 101 used in the first embodiment, while FIG. 3(b) is a flowchart showing the flow of the operations of the first embodiment.

First, the image pickup optical system 101 using the first embodiment will be described using FIG. 3(a).

In FIG. 3(a), the image pickup optical system 101 comprises a so-called bifocal lens which combines a lens portion 123 with a short focus distance f (f=4.6 mm for example) and a lens portion 121 with a long focus distance f (f=5.0 mm for example) and when viewed from the optical axis 111 side, a donut shaped lens portion 121 is arranged concentrically on the periphery of the round lens portion 123. Thus, when positions of the image pickup optical system 101 and the image pickup element 103 are arranged such that the optical bundle 125 from the lens portion 121 forms images on the image pickup surface 103a of the image pickup element 103 and the light bundle 127 from the lens portion 123 forms images further forward than the image pickup surface 103a of the image pickup element 103, and at the image pickup surface 103a of the image pickup element 103 the image is blurred.

The structure of the image pickup optical system 101 is not limited to the above structure and for example, the lens with a long focal distance may be arranged at the center and the lens with the short focal f may be arranged on the periphery. In addition, the focal distances f may be the same and the rear main point position are different, or in other words the two lens that have different image formation positions may be arranged so as to be concentric. Furthermore, image pickup optical system 101 is not limited to bifocal lens and may for example be a progressive multifocal lens in which the focal distance f changes progressively from the center to the periphery.

An axial chromatic aberration and local difference of diffractive power of the image pickup optical system are designed to form a plurality of images of the same object at mutually different plural positions on the optical axis of the image pickup optical system. Appropriate positions of the mutually different positions are determined by a final image creation means. That is, the distance between the mutually different positions can be selected within a rage where the original images can be restored by the extended depth of field processing.

The image pickup element 103 is a spectroscopic image pickup element shown in FIGS. 2(a) and 2(b) and the image in which an image that is focused by the aforementioned lens portion 121 and the blurred image from the lens portion 123 are superposed is subjected to photoelectric conversion and the image signal 103s is output. As described in FIG. 1, the image signal 103s of the image pickup element 103 is input to the image calculation section 201 via the image pickup control section 105 and the interface 107 and subjected to extended depth of field processing and thus extended depth of fields that are focused for all distances from near distance to far distance are formed.

Next, the image pickup operation in the first embodiment will be described using FIG. 3(b) In FIG. 3(b), in Step S101, photoelectric conversion is performed by the image pickup element 103 and digital image data 105i for the image signal 103s of the image pickup element 103 is created by the image pickup control section 105, and then in Step S103 color information for the three colors R, G and B of the image of the subject is created from the image data 105i for each position on each of the pixels 103c of the image pickup element 103.

For the image pickup element ID having the Bayer arrangement shown in FIGS. 5(a) and 5(b), is necessary to perform the color interpolation process and create color information for the three colors R, G an B at the position of each of the pixels here, but there is no need for this in the first embodiment and color information for the three colors R, G and B at the positions of each image element can be formed directly from the digitalized image data 105i. Of course there is no resolution insufficiency or occurrence of pseudo colors.

For example, in the 2 million pixel image pickup element ID having the Bayer arrangement, in order to interpolate color information for one pixel, an average range for the peripheral 5 pixels×5 pixels is assumed. Because there are pixels that use at least four interpolations (for example the case where R interpolation is performed at the B pixel position) in the peripheral 5 pixels×5 pixels, and for 2 million pixels, it is necessary to perform additions at least 8 million times and subtractions at least 2 million times for one color interpolation and in order to obtain three color data at each pixel position, at least 16 million additions and 4 million subtractions are required.

In the first embodiment, these calculations are unnecessary and the calculation time can be saved and energy can be conserved. Furthermore, by reducing the calculation load, a CPU with low processing capability can be used and this contributes to reduced cost.

FIG. 3(b) will be referred to once again. In Step S105, color information for the three colors R, G and B are subjected to extended depth of field processing using the image calculation section 20 and focused extended depth of fields can be formed for all distances from near distance to far distance. In Step S107, the extended depth of field is output. In the case of still images, this ends all the operations. In the case of moving images, the process returns to Step S101 and the subsequent operations are repeated.

In the first embodiment, the image calculation section 201 may be the same image quality improvement processing device 30 shown in FIG. 1 of the aforementioned Patent Document 1, and the extended depth of field processing performed here may be the same as the image quality improvement process performed in the image quality improvement processing device 30.

As shown in the first embodiment, a plurality of superposed images is subjected to photoelectric conversion and in order to calculate the extended depth of field from this image, a “process of referring to multiple pixels and determining the respective pixel value” which uses a convolution processing becomes necessary. In this process, one pixel value is not that important for determining pixel value, but rather pixel value largely depends on the statistical trends for the pixel value of the peripheral pixels. That is to say, even if abnormal regions are present to the extent that the number of pixels is high, the error is dispersed peripherally and thus is not remarkable.

A state where a light from a point of an object is expanded on an image pickup element by an image pickup optical system is called PSF (point spread function). When the image pickup optical system realizes a plurality of image forming relationships, PSF is different in each image formation. When a formed image and a PSF corresponding to the image is known, the original image of an object can be obtained by a convolution processing. Even for a defocused image, if a PSF corresponding to the formed image in the defocused state, it is possible to reproduce a sharp image from the defocused image. By calculating each PSF for the plurality of image forming relationships of the image pickup optical system of the present application, it is possible to perform convolution processing for the focused image and the defocused image with each PSF corresponding to each image. Then, respective sharp images can be reproduced. And then, by combining those images, a deep image can be obtained. When combining those images, if image forming positions are changed depending on the wavelength, a PSF necessary for reproducing calculation corresponds to each wavelength. If the image pickup optical system shifts the image forming relationships between R, G and B, PSF for use in a convolution calculation corresponds to each image forming relationship of R, G or B.

For example, if the case where there is foreign matter on the pixel of the image pickup element is considered, the pixel on which there is foreign matter becomes completely dark because the foreign matter forms a shadow and thus only black image signals can be given out. In the image pickup element ID with the Bayer arrangement shown in FIGS. 5(a) and 5(b), in the case where there is foreign matter on the pixel IC, black image signal for the pixel on which there is foreign matter is used in interpolation at the time of forming color information at not only the pixel that has the foreign matter, but also the peripheral pixels of the pixel with the foreign matter. As a result, the shadow of the foreign matter causes deterioration in image quality to the peripheral pixels and to around severalfold region of the image with the foreign material. If the region used in the color interpolation process is extended, the effect of the foreign material can be reduced, but as described above, a large amount of calculation is required for the color interpolation process and this is unsuitable as the calculation load is further increased.

To solve this problem, in the spectroscopic image pickup element 103 used in the present invention, color interpolation process and addition of color information for the three colors R, G and B at each pixel position is not performed and thus in the case where foreign matter and the like is present on the pixel 103c of the image forming element 103, only the pixel 103c that has the foreign material outputs the black image signal 103. However, in the first embodiment, even if only the pixel 103s outputs black image signal in this manner, if the pixels aside from the those at the periphery which are used in the convolution processing can output black image signals normally, error is dispersed at the periphery and thus an extended depth of field can be calculated as an image without discomfort and thus the effect of the foreign matter is not problematic.

As described above, in the first embodiment, the subject image in which a focused image and a blurred image are superposed and that was formed by a bifocal lens formed of two lens portions with different focal distances is photographed using a spectroscopic image pickup element which can perform photoelectric conversion of lights of three colors independently, and thus resolution insufficiency and pseudo colors and the like do not occur and an extended depth of field forming device which is capable of forming high quality extended depth of fields is provided. In addition, huge amounts of calculation for color interpolation process is unnecessary and the calculation time can be saved and energy can be conserved and a CPU with low processing capability can be used and this contributes to reduced cost. Furthermore, by using the spectroscopic image pickup element, the effect of the foreign matter is not problematic.

### Second Embodiment

Next the second embodiment of the present invention will be described using FIGS. 4(a) and 4(b) FIGS. 4(a) and 4(b) are pattern diagrams for describing the second embodiment of the present invention and FIG. 4(a) shows the structure of the image pickup optical system used in the second embodiment, while FIG. 4(b) is a flowchart showing the flow of the operations of the second embodiment.

First the image pickup system 101 used in the second embodiment will be described using FIG. 4(a).

In FIG. 4(a), the image pickup system 101 is designed such that the axial chromatic aberration on the axis is large and the focal distance is different for each light wavelength. For example, the focal distance on R, fr=5.2 mm; the focal distance on G, fg=5.0 mm and the focal distance on B, fb=4.8 mm. Thus if for example the positions of the image pickup optical system 130 and the image pickup optical element 103 are arranged such that the G bundle 133 is focused on the image pickup surface 103a of the image pickup element 103, because the R bundle 131 is focused further to the rear than the image pickup surface 103a of the image pickup element 103, the image is blurred on the image pickup surface 103a of the image pickup element 103. Similarly, the B bundle 135 is focused further to the front than the image pickup surface 103a of the image pickup element 103 and the image is blurred on the image pickup surface 103a of the image pickup element 103.

As is the case in FIGS. 3(a) and 3(b), the image pickup element 103 is the spectroscopic image pickup element shown in FIGS. 2(a) and 2(b) and an image resulting from superposing the image focused by the G bundle 133 and the blurred image from the R bundle 131 and the B bundle 135 is subjected to photoelectric conversion and the image signal 103s is output. As shown in FIG. 1, the image signal 103s from the image pickup element 103 is input into the image calculation section 201 via the image pickup control section 105 and the interface 107, and extended depth of field processing is performed and an extended depth of field is performed.

For each wavelength of the light wavelength region used, the value of the distance on the axis that is indicated by an image surface reduced value is sd, where the focal point is focused with the distance. In the case where images are obtained that are in focus along a wide range of the image capturing distance (depth direction), a large sd value is set. Accordingly, chromatic aberration on the axis must be set large. In regular lens, in order to eliminate chromatic aberration on the axis, a lens (group) with positive refractive power is set to have low dispersion, while a lens (group) with negative refractive power is set to have high dispersion. By reversing the relationship between code and dispersion of the refractive power, chromatic aberration on the axis can be made large. If the difference between the back focal length fmax of the wavelength which has the longest back focal length among wavelengths of light used for the optical system and the back focal length fmin of the wavelength which has the shortest back focal length among the wavelengths of light used for the optical system is set to be the same as sd or set to be large, images are obtained that are focused at each of the wavelengths within the range of sd, and by subjecting these images to image processing, extended depth of images that are focused in the entire sd range are formed.

Image focus is determined by whether the blur amount of the optical image on the image capturing surface is kept within the pixel pitch. Normally, if the pixel pitch is larger than the blur amount, blurring on the image is not observed. Furthermore, if known image quality improvement techniques are used, even if the pixel pitch is about twice the blur amount, sharp images can be obtained. The size of blurring that can be resolved using image quality improvement techniques is called the blur correction amount and is normally expressed using pixels. The value of sd is that range in which the sharp images can be obtained and this value is given to the range that shows the same blur amount in the vicinity with the focal point as its centre. The vicinity difference is sd.

To give a specific example, in the case of an image capturing optical system in which the F value is 1.4, the blur correction amount is 1.1 pixels and the pixel pitch is 0.1 μm, 0.154 which is the multiple of these three values is equivalent to sd/2. That is to say, the sd value is 0.308 μm. In this manner, the value of sd depends on the specification of the extended depth of field forming device such as the F value of the image capturing optical system, the pixel pitch of the image capturing element and the blur correction amount of the image quality improvement technique.

Next, the image pickup operation in the second embodiment will be described using FIG. 4(b) In FIG. 4(b), in Step S201, the photoelectric conversion is performed by the image pickup element 103 and digitalized image data 105i from the image signal 103s of the image pickup element is created by the image pickup control section. In Step S203, color information for the three colors R, G and B of the image of the subject is created from the image data 105i for each pixel 103c position of the image pickup element 103. As is the case in FIG. 3(b), in the second embodiment also the color interpolation process is not necessary and huge amounts of calculations can be omitted. Of course, resolution insufficiency and pseudo colors do not occur.

In Step S205, the color information for the three colors R, G and B are subjected to extended depth of field processing by the image calculation section 201 and focused extended depth of fields are formed for all distances from near distance to far distance. In Step S207, the extended depth of fields are output. In the case of still images, this ends all the operations. In the case of moving images, the process returns to Step S201 and the subsequent operations are repeated.

The extended depth of field process in the second embodiment may be the same as the process of the first embodiment and for example, the output with the highest contrast of the R, G and B outputs of the image signal 103s output from the image pickup element 103, is used as the brightness signal—color difference signals are created from the remaining outputs and the extended depth of field is calculated from these signals using the same extended depth of field process as that in the aforementioned Patent Document 1. If the aforementioned method is used, because the output with the highest contrast from among the R, G and B outputs of the image signal 103s output from the image pickup element 103 is used as the brightness signal, focused images can be obtained provided that the distance range is that in which one of R, G and B is focused.

As described above, in the second embodiment, the subject image resulting from superposing the images formed by the image pickup optical system with different focal distances due to light wavelength is captured using a spectroscopic image pickup element that is capable of independently performing photoelectric conversion of three colors of light and thus resolution insufficiency and pseudo colors do not occur and an extended depth of field forming device which can form high quality extended depth of fields is provided. In addition, increased calculation for color interpolation process is unnecessary and the calculation time can be saved and energy can be conserved and CPUs with low processing capability can be used and this contributes to reduced cost. Furthermore, by using the spectroscopic image pickup element, the effect of the foreign matter is not problematic.

In addition, in the first and second embodiments, by using as the image pickup system, an optical element with different refractive power due to the light polarizing direction, it is also possible to form a subject image in which a plurality of images are superposed, but the aforementioned method using the axial chromatic aberration has a simpler optical system and thus is more preferable.

As described above, according to the present invention, by photographing a subject image in which a focused image and a blurred image are superposed using a spectroscopic image pickup element which can perform photoelectric conversion of lights of three colors independently, resolution insufficiency and pseudo colors and the like do not occur and an extended depth of field forming device which is capable of forming high quality extended depth of fields is provided. In addition, huge amounts of calculations for color interpolation process is unnecessary and the calculation time can be saved and energy can be conserved and a CPU with low processing capability can be used and this contributes to reduced cost. Furthermore, by using the spectroscopic image pickup element, the effect of the foreign matter is not problematic.

According to the present invention, because an image pickup element comprising pixels that can perform photoelectric conversion of lights of multiple wavelengths independently, resolution insufficiency and pseudo colors and the like do not occur and an extended depth of field forming device which is capable of forming high quality extended depth of fields is provided.

It is to be noted that the detail structure and operations of each component forming the extended depth of field forming device of the present invention may be suitably modified provided that they do not depart from the spirit of the present invention.

What is claimed is:

1. An extended depth of field forming device comprising:
an image pickup element which has a plurality of pixels and performs photoelectric conversion of an optical image and generates image signals based on the optical image;
an image pickup optical system which creates an optical image of a subject; and
an image calculation section which calculates image signals generated by said image pickup element for generating an extended depth of field,
wherein each pixel of the image pickup element performs photoelectric conversion of light including a plurality of wavelength regions, independently at each layer of the image pickup element located in different depth and the image pickup optical system forms a plurality of images at different positions on the optical axis and the image calculation section creates color information of the optical image of the subject for each pixel.

2. The extended depth of field forming device according to claim 1, wherein the plurality of wavelength regions comprises red color wavelength region, green color wavelength region and blue color wavelength region.

3. The extended depth of field forming device according to claim 2, wherein said image pickup element creates red color information, green color information and blue color information, utilizing difference of optical absorption length of light in a depth direction of each pixel.

4. The extended depth of field forming device according to claim 1, wherein said image pickup optical system comprises at least two members having different focal distances.

5. The extended depth of field forming device according to claim 4, wherein said image pickup optical system has two focal distances different each other.

6. The extended depth of field forming device according to claim 4, wherein said image pickup optical system has a plurality of focal distances which are progressively different.

7. The extended depth of field forming device according to claim 1, wherein said image pickup optical system has a large axial chromatic aberration so as to satisfy a following relationship of,

|fmax·fmin|≧sd
wherein fmax indicates a back focal length of a wavelength that has the longest back focal length among wavelengths of light used for the optical system, fmin indicates another back focal length that has the shortest back focal length among the wavelengths of light used for the optical system and extended depth of field is expressed as sd indicated by an image surface reduced value.

8. The extended depth of field forming device according to claim 7, wherein said image pickup optical system has different focal distances for different wavelengths of red color, green color and blues color.

9. The extended depth of field forming device according to claim 1, wherein said image calculation section performs convolution processing to image signal.

10. The extended depth of field forming device according to claim 9, wherein the convolution processing is performed by using a PSF (point spread function).

11. The extended depth of field forming device according to claim 10, wherein the PSF is prepared for each colors of red, green and blue.
